(19) United States
(12) Patent Application Publication
(10) Pub. No.: US 2022/0254183 A1
(43) Pub. Date: Aug. 11, 2022

(54) METHOD AND SYSTEM FOR NON-INVASIVELY MARKING AND DISCRIMINATION OF LIVESTOCK

(71) Applicant: Touchless Animal Metrics, SL, Barcelona (ES)

(72) Inventor: Ivan Amat Roldan, Barcelona (ES)

(73) Assignee: Touchless Animal Metrics, SL, Barcelona (ES)

(21) Appl. No.: 17/612,348

(22) PCT Filed: May 15, 2020
(86) PCT No.: PCT/EP2020/063635

§ 371 Date: Nov. 18, 2021

(30) Foreign Application Priority Data
May 20, 2019 (EP) 19382397.8

(51) Int. Cl. G06V 40/10

(52) U.S. Cl. CPC G06V 40/103

(57) ABSTRACT

A method and system of non-invasively marking and discrimination of livestock are disclosed. The method comprises receiving, by a computing system, information related to a livestock animal and determining at least one feature of the livestock animal using the received information; and marking, by a light-based marking device operatively connected to the computing system, the livestock animal by projecting an identifier related to the determined feature, on a part of or in an area nearby the livestock animal, or in at least one screen, wherein said marking is performed from a given distance from the livestock animal, said given distance being comprised within a given marking range.

### TECHNICAL FIELD

The present invention relates to a method and system of non-invasively marking and discrimination/identification of livestock. The marking targets the right animal for unambiguous identification of each livestock within a group of animals by means of projecting light including images/descriptors (i.e. an identifier) in a specific arrangement near or on the livestock related to any aspect/feature of the livestock such as weight, health, identification code, age, body temperature, body sizes and posture, among others. Therefore the livestock can be discriminated.

### BACKGROUND OF THE INVENTION

Identification of animals is an important task in livestock management that requires intensive efforts. For example, identification of livestock animals at the right weight for finalization, identification of animals that are growing at normal or abnormal rates, identification of animal with illness, etc. These tasks are at the present time done manually and in a subjective manner, which is prone-error.

Currently, livestock animals are weighed one or two days before sending them to the abattoir and marked with spray. Spray only lasts few days, and in general, it is a problem to recognize the spray marks after two days. Beyond the persistence of spray or any other ink, this approach presents problems in terms of biosafety as the potential toxicity or effects on the animal or the meat. Moreover, the physical interaction between the animal and the operator provokes stress to the animal and in some cases danger for the operator.

Some patents or patent applications are known in the field, for example EP-A1-3173751 discloses a system incorporating a dynamic weighing platform which indicates the weight value obtained. The system also comprises a control device, a detection system and a marking device. The dynamic weighing platform is foldable and portable. The control device comprises an interface for a user to interact with the system, with a data processor connected to the dynamic weighing platform. The detection system comprises at least two detection devices with photocells connected to the control device. The marking device comprises at least two actuators, to activate the corresponding two marking elements, connected to the control device. The marking device also incorporates sprays of different colors.

WO-A1-2016135684 relates to a method for calculating the body condition score—BCS, the weight of an animal and its state of fertility by means of the mathematical processing of some characteristic morphological traits of the observed subject, which makes use of at least one contact or no-contact detection device of a profile of the animal, at least a data processing unit and a program that implements a specific mathematical method of interpretation. In order to highlight a specific anatomical region of the observed subject, so that it can be detected by means of a video recording apparatus, a structured light source can be used. Assuming that the pattern consists of one or more rows transverse to the spine of the observed subject in a specific anatomical region, it is possible to project a pattern (e.g. shaped light) on the body of the subject under examination, in the anatomical region of interest. In this case, an apparatus will include a coherent (e.g. a laser line generator) or not coherent light source, this light source projecting on the subject a set of discrete or continuous points, in order to highlight the profile on the morphological interest region.

US-A1-2019133087 discloses a management apparatus that includes a control unit. The control unit extracts, on the basis of first information that is generated by a sensor device worn by an individual and is related to a living body of the individual, a specific individual satisfying a predetermined condition, and generates, on the basis of position information related to a position of the specific individual, search information for causing a mobile object to move to the position of the specific individual. In present invention the individuals (i.e. the animal) do not have to wear any sensor in order the information thereof be determined/computed.

More solutions are therefore needed for non-invasively (i.e. touchless) marking and discrimination of livestock animals, while the animals are freely moving in a farm or in its natural environment, hence assisting in the management tasks of such livestock.

### DESCRIPTION OF THE INVENTION

Present invention proposes, according to a first aspect, a method of non-invasively marking and discrimination/identification of livestock. The method comprises receiving, by a computing system, information related to a livestock animal such as a pig, a bull, a cow, a sheep, a broiler, a duck or a chicken, among others, while the animal freely moves in a farm or in its natural environment; determining one or more features of the livestock animal using the received information; and marking the livestock animal, by a light-based marking device operatively connected to the computing system, by means of projecting an identifier related to (or associated to) the obtained feature, on a part of the livestock animal, in an area nearby the livestock animal, or in at least one screen (for example, of an optical head-mounted display such as the Google Glasses™). In the proposed method, the marking step is performed from a given distance from the livestock animal, where said given distance is comprised within a given light range of said light-based marking device.

Thus, the precise marking/signaling facilitates the discrimination/identification of the livestock animal as the projected identifier/discriminant is indicative or instructs how the livestock animal has to be classified/sorted within a group of livestock animals, in a touchless manner, or the identifier shows that a further action might have to be taken, for example by a farm operator. In this manner, present invention substitutes previous marking strategies using sprays or other physical marking approaches, reducing the physical interaction between the livestock animal and operator in a way stress of the animal is reduced as well as operator has lower chances to be injured.

It should be noted that the method is applicable to the marking of any object.

According to the proposed method, the received information can comprise any of a two-dimensional image of the livestock animal, a three-dimensional point cloud image of the livestock animal or a depth profile of the livestock animal (e.g. a number of spatial relationships or a graph in which different information of the animal is related), and the distance between the livestock animal and the acquisition system used for acquiring the two-dimensional image or the position or coordinates of the livestock animal.

In an embodiment, said one or more features is/are determined by implementing, by a processing unit of the computing system, a characterization algorithm that uses the received information and an a priori model of the livestock animal. The a priori model preferably includes indicators linking different parts, contours or shapes representative of the livestock animal or indicators about psychological conditions of the livestock animal. Alternatively, in another embodiment, the one or more features is/are determined by the computing system matching the received information with information stored in a memory or database.

According to the proposed method, the one or more features can include a body parameter of the livestock animal such as the weight, the temperature, the body size and/or the age; and/or a condition of the livestock animal, for example if the animal is sick, healthy or unhealthy, if needs to be moved to another pen of the farm, or if the animal is identified as aggressive. The one or more features in some embodiments can also include the coordinates, position or posture of the livestock animal.

In an embodiment, the identifier comprises a text message showing the computed feature(s). Alternatively, in another embodiment, the identifier comprises a symbol including a color mark. For example, if the symbol marked/projected is green it can mean that a further action has to be taken by the operator, for example the animal has to be taken to the abattoir, whereas if the symbol marked/projected is red it can mean that the animal does not meet the required weight.

The part of the livestock animal or said area can be calculated by the computing system based on the type of livestock animal to be marked/signaled. That is, the computing system by implementing a decision algorithm can decide where to project the identifier to obtain proper discrimination/identification of the livestock. For example, the computing system can decide to project the identifier on a specific body part of a pig or in an area/zone nearby a cow or a broiler, or another livestock.

In an embodiment, the received information comprises a two-dimensional image including a plurality of livestock animals, and a value of the distance between the livestock animals and the acquisition system used for acquiring said image or the position or coordinates of the livestock animals. In this case, a processing unit of the computing system can identify each one of the livestock animals included in the two-dimensional image by implementing a segmentation algorithm and decide which one of the livestock animals have to be marked by implementing a decision algorithm.

Present invention also proposes, according to a second aspect, a system for non-invasively marking and discriminating/identifying livestock comprising a computing system having one or more processing units configured to receive information related to at least one livestock animal and to determine/compute at least one feature of the livestock animal using the received information. The system also comprises a light-based marking device operatively connected to the computing system, located at a certain distance from the livestock animal, and configured to mark/signal the livestock animal by projecting an identifier related to (or associated to) the determined/calculated feature, on a part of or in an area nearby the livestock animal, or in at least one screen, wherein said certain distance is comprised within a given marking range to achieve proper identification/discrimination of the livestock.

According to the proposed system, the computing system and the light-based marking device can be arranged in a hand-held device, in an unmanned aerial vehicle or in an optical head-mounted display. Alternatively, the computing system and the light-based marking device can be arranged in a device mounted in a fix position in the farm or mounted in a movable structure in the farm.

In an embodiment, the system also includes an image acquisition unit to acquire (one or more) two-dimensional image(s) of the livestock animal(s). The image acquisition unit such as a camera can be installed in a particular area of the farm, configured to be oriented towards the different pens, or can be integrated in said hand-held device, in the unmanned aerial vehicle or in the optical head-mounted display.

In another embodiment, the system includes a series of image acquisition units to acquire (one or more) two-dimensional image(s) of the livestock animal(s). In this case, the series of image acquisition units can be positioned in different areas in the farm or in the different pens, such that each image acquisition unit has its field of view oriented towards a different pen.

According to the proposed system, the light-based marking device can comprise a coherent or not coherent light source such as a laser, a spatial light modulator, a LCD, a lamp, etc. Moreover, the light-based marking device can also include a beam shaping device/unit such as a hologram, a spatial light modulator, a deformable mirror, a galvanometric mirror, a spinning disk, a diffractive optical element, a phase mask, a prism, or even an electro-optical effect to project the identifier from a coherent light source.

### BRIEF DESCRIPTION OF THE DRAWINGS

The previous and other advantages and features will be more fully understood from the following detailed description of embodiments, with reference to the attached figures, which must be considered in an illustrative and non-limiting manner, in which:

FIG. 1 shows some examples of how an identifier can be presented, according to different embodiments of the present invention to produce different types of marking/signaling. (A) animal weight is projected on top of the skin of a pig; (B) a laser beam signals a sheep, tilting can be obtained for example by a pair of galvanometric mirrors; (C) a star is projected on top of the skin of a cow with a shaped laser beam obtained for example by means of a laser beam and a phase plate or hologram; (D) the same of (A) but projected near the livestock animal; (E) the same of (B) but projected near the livestock animal; and (F) the same of (C) but projected near the livestock animal.

FIG. 2 illustrates different examples of the features that can be determined and projected by the present invention. (A) shows a situation in which a sick pig 100 is marked; (B) shows a pig that needs to be moved to another pen; and (C) shows a pig that has been detected as aggressive.

FIG. 3 shows an example of an unmanned vehicle including the proposed system. (A) Pig with its weight projected nearby it to result in precise and non-invasive marking/signaling and direct discrimination/identification among livestock; (B) Sheep with a laser beam; and (C) Cow with a shaped laser beam projected on it.

FIG. 4A shows an example of the proposed device mounted on a static position for each pen in a farm. FIG. 4B shows an example of the proposed device mounted on a rail which can be moved through different pens in the farm.

FIG. 5A illustrates an example of the proposed device mounted on a rail and a network of cameras that track livestock animals of each pen. FIG. 5B illustrates an example of the proposed device mounted on a rail and integrating a pig weighing device based on image analysis and a network of cameras that track livestock animals individually.

FIG. 6 illustrates an embodiment in which the marking and discrimination/identification of the targeted livestock is made via augmented reality images in an optical head-mounted display.

FIG. 7 illustrates an embodiment in which the marking and discrimination of the targeted livestock is made via a screen of a tablet or smartphone.

FIG. 8 graphically illustrates an embodiment of a method of non-invasively marking and discrimination of livestock.

FIG. 9 graphically depicts an embodiment in which multiple livestock animals are marked at the same time. In FIG. 9A only a label identifying the different animals is projected whereas in FIG. 9B the weight of each animal is projected on each animal for discrimination thereof.

FIG. 10 shows an embodiment of the proposed device that can be mounted in a fix position or in a movable structure in a farm.

FIG. 11 shows another embodiment of the proposed device.

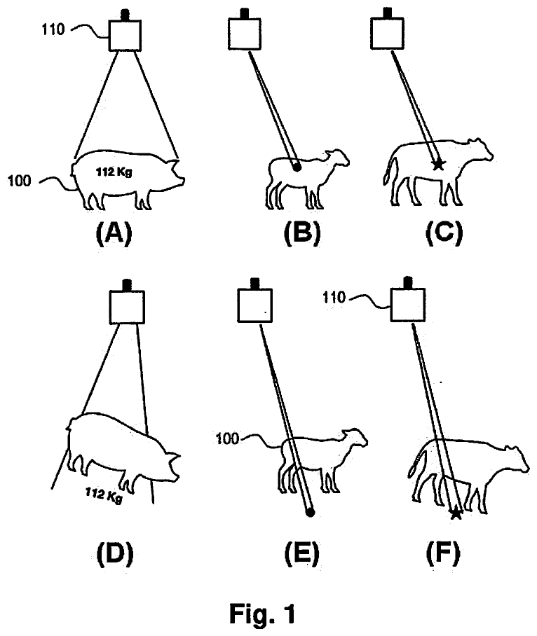

### DETAILED DESCRIPTION OF THE INVENTION AND OF PREFERRED EMBODIMENTS

Present invention provides a touchless marking/signaling approach via a light-based solution for assisting in the management of livestock. The marking/signaling eases the identification of the livestock by projecting, using light, images/descriptors in a specific arrangement near or on the livestock. In this manner, the proposed method and corresponding system (sometimes implemented as a device or apparatus) substitutes the use of spray or any other physical marking/signaling strategy involving direct physical contact with the livestock animal.

According to the present invention the livestock animal 100 (or living specimen) can comprise a pig, a bull, a cow, a sheep, a broiler, a duck, a chicken, etc. Nonetheless, it should be noted that the invention is applicable to the marking of any object.

In an embodiment, present invention provides a device 110 comprising a computing system 111 with one or more processing units to receive information related to the livestock animal 100 in the range of marking (from a few meters to hundreds of meters). The received information can include one or more two-dimensional image(s), a three-dimensional point cloud image, or a depth profile of the livestock animal 100 and a value of the distance between the livestock animal 100 and an acquisition system 125 (for example a camera), see FIG. 5, used for acquiring said two-dimensional image or the position or coordinates of the livestock animal 100. With the received information the computing system 111 determines/calculates a feature (it can obtain more than one) of the livestock animal 100. The information can be received either directly from the camera(s) 125, from a cloud computing server, or from a handheld device for automated parameters calculation of livestock animals such as the one taught by WO-A1-2015193711 of the same inventors of present invention.

The device 110 also includes a light-based marking device 112 such as a coherent or not coherent light source, particularly a laser, operatively connected to the computing system 111 and located at a certain distance from the livestock animal 100, to project an identifier linked to said determined feature on or nearby the livestock animal 100. Additionally, the light-based marking device 112 can also include additional beam shaping devices/units such as holograms, spatial light modulators, deformable mirrors, galvanometric mirrors, spinning disks, etc. to project said identifier and obtain direct marking of the livestock.

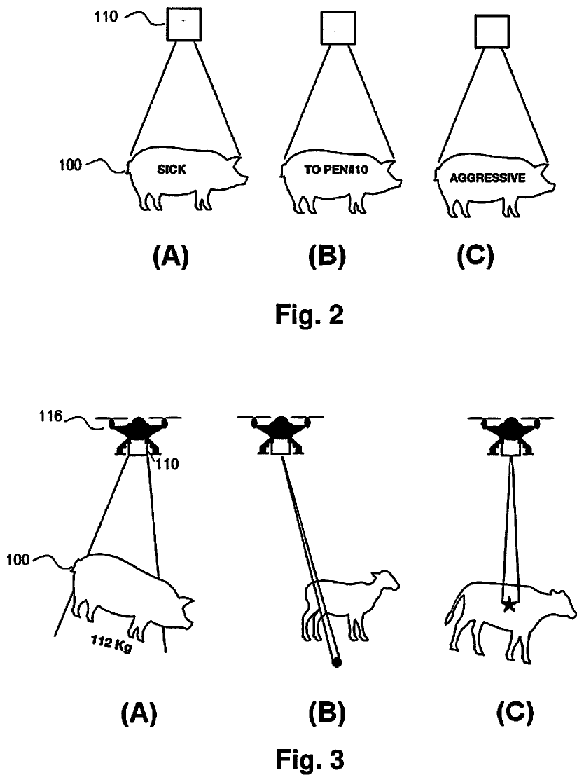

The determined feature can include a body parameter such as the weight, temperature, body size, age, etc. of the livestock animal 100. However, because not only a body parameter can be informative when managing livestock, as shown in FIG. 2, other features can also be obtained and projected by present invention that result in livestock marking and identification/discrimination. For example, a condition of the livestock animal 100 such as if the animal is sick, healthy, unhealthy, if needs to be moved to another pen 105 of the farm or if the animal is identified as aggressive. This saves a lot of time and efforts in identifying the right livestock animal 100 and minimizes the interaction with the livestock animal 100.

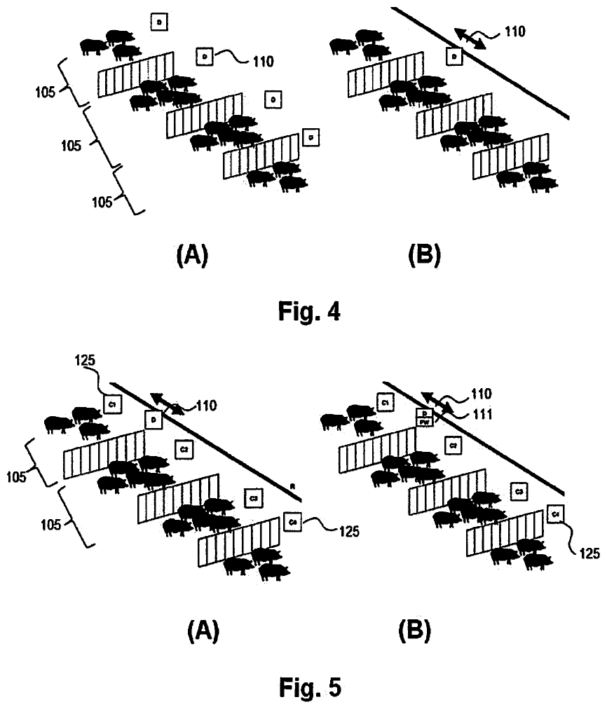

With reference to FIG. 3, therein it is illustrated another embodiment of the present invention. In this particular case the proposed device 110 is arranged in an unmanned aerial vehicle 116 such as a drone. Alternatively, the computing system and the light-based marking device can be integrated in a handheld device (not shown), such as the device taught by WO 2015193711. Even, the device 110 can be mounted in a fix (see FIG. 4A) or in a movable structure (see FIG. 4B) of the farm.

The unmanned aerial vehicle 116 can be further complemented by a positioning system, for example a GPS in a form of a collar for a specific livestock animal 100 (like Iberian pig or fighting bull) that is localized by the computing system and the unmanned aerial vehicle 116 goes to find the livestock animals 100 fulfilling some condition. For example, when the computing system knows that there are 50 Iberian pigs with the right weight for the abattoir sends (for example via a communication unit thereof) a warning to the farmer, and proposes a route to the farmer. The farmer follows these instructions and loads the right pigs. In case of having many livestock animals together, the unmanned aerial vehicle 116 will further mark the individual livestock animal.

Device 110 of FIGS. 4A and 4B can be integrated or complemented with different systems. For example, a weighting system based on image analysis such as the device taught by WO 2015193711 and/or a number of cameras 125 that perform animal surveillance, which compute for example, tracking for analysis of motion to estimate health status or identify a specific livestock animal 100 that has been continuously tracked, as shown in FIG. 5.

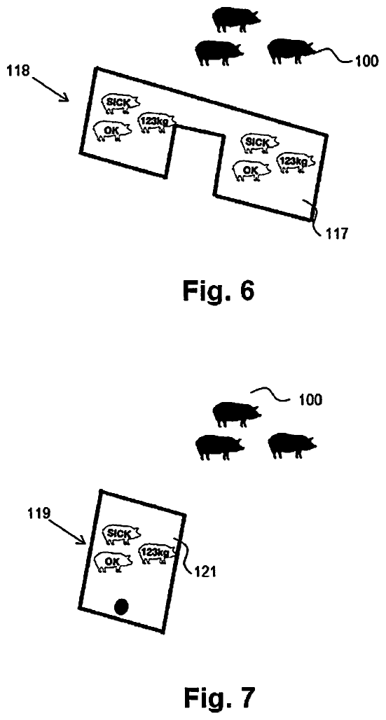

With reference now to FIG. 6, therein it is illustrated another embodiment of the present invention in which the livestock marking is performed by projecting/displaying the identifier relating to the determined/computed feature(s) via augmented reality images in the screens 117 of an optical head-mounted display 118 such as the Google Glasses™. FIG. 7 shows a screen 121 of a tablet or smartphone 119 showing the real image of the livestock animal(s) 100 with the enriched information. In these two embodiments, the computing system can have integrated therein an APP or software application executing an algorithm to obtain the one or more features of the livestock animal 100 based on the received information. It should be noted that in both these embodiments the light-based marking device is integrated in the optical head-mounted display 118 or tablet or smartphone 119.

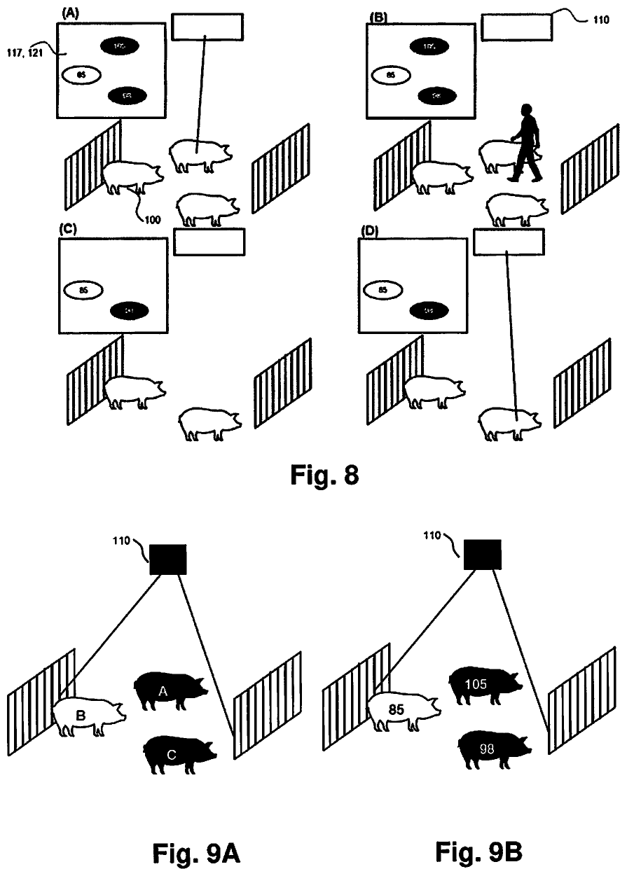

FIG. 8 graphically depicts an embodiment of the method for non-invasively marking and discrimination of livestock. In this case, once the device 110 has received the information related to the livestock animals 100, has identified the latter, decided which one has to be marked and obtained the one or more features, the device 110 (see FIG. 8A) via the light-based marking device points a first livestock animal 100 and projects the identifier related to the obtained feature(s). A technician/operator of the farm can then approach the marked livestock animal 100 (see FIG. 8B). Once the marked livestock animal has been moved (FIG. 8C), for example to the abattoir, the device 110 can point a next livestock animal 100 (FIG. 8D).

FIG. 9 shows an embodiment in which different livestock animals 100 can be marked/signaled at the same time.

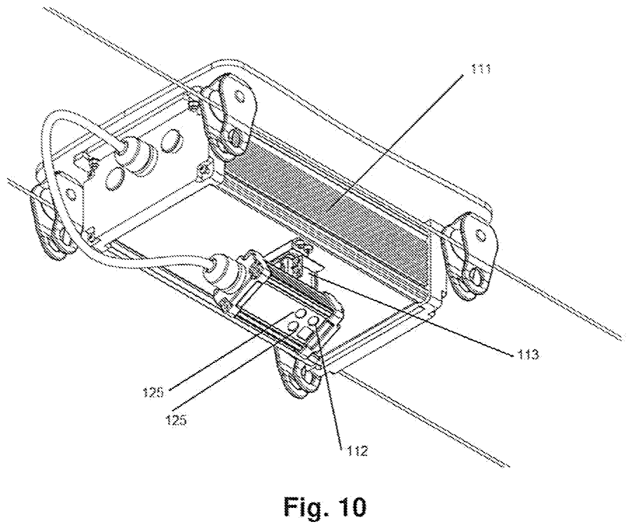

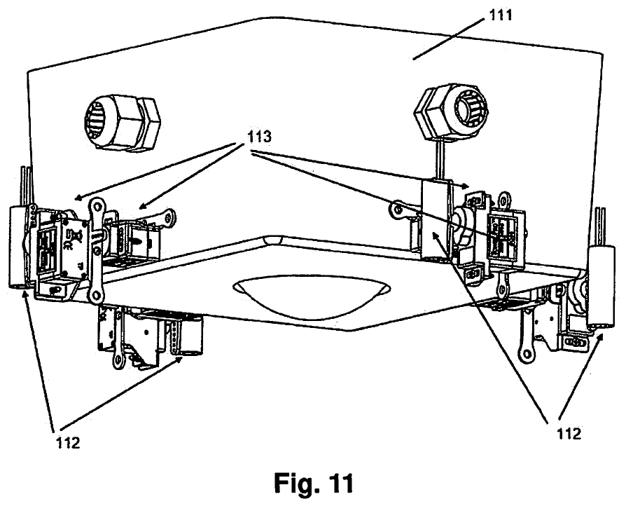

FIGS. 10 and 11 show other embodiments of the proposed device. In FIG. 10, the device 110 comprises two cameras 125, a computing system 111 (enclosed within an enclosure) to process the acquired image(s), a laser pointer 112 and a pair of servo motors 113. Laser pointer 112 can also be changed by a projector. In FIG. 11, the device 110 comprises four laser pointers 112 and four pairs of servo motors thus up to four different livestock animals can be marked/signaled with the same device 110. The laser pointers 112 can also be integrated with a shaping device.

Other embodiments containing projectors or light shaping devices can be also provided to indicate complex patterns for one or multiple livestock animals 100. Pulsed light and fast moving motors, or by means of refraction, reflection, dispersion, deflection or diffraction of light (by means of SLMs, non-linear optical or electro-optical effects) can be designed also to point multiple targets or display/present complex patterns with a single device to simultaneously mark and identify/discriminate multiple livestock animals within livestock. Also, LED or laser arrays (e.g. vertical-cavity surface emitting lasers, VECSELs) can be engineered to generate light patterns that can be electronically controlled.

The proposed invention may be implemented in hardware, software, firmware, or any combination thereof. If implemented in software, the functions may be stored on or encoded as one or more instructions or code on a computer-readable medium.

The scope of the present invention is defined in the following set of claims.

1-15. (canceled)

16. A device for touchless signaling and identification of livestock, the device being operatively arranged in an unmanned aerial vehicle or being mounted on a fix or movable structure of a farm, the device comprising:
a computing system having one or more processing units configured to:
receive information related to at least one livestock animal;
obtain at least one feature of the at least one livestock animal by implementing a characterization algorithm that uses received information related to the at least one livestock animal and an a priori model of the at least one livestock animal, said a priori model including indicators linking different parts, contours or shapes representative of the livestock animal or indicators about psychological/health/behavior conditions of the livestock animal, or by matching said received information relating to the at least one livestock animal with information previously stored in a memory or database; and
decide a part of the livestock animal or an area nearby the livestock animal where to project an identifier, based on the type of livestock animal to be signaled; said identifier associated with said at least one feature obtained from the livestock animal; and
a light-based marking device operatively connected to said computing system and configured to mark the livestock animal by projecting said identifier based on the decided part of the livestock animal or based on the decided area nearby the livestock animal, said light-based marking device comprising a coherent or not coherent light source and being located at a given distance from the livestock animal when performing a marking, said given distance being comprised within a given light range of said light-based marking device.

17. The device of claim 16, further comprising at least one image acquisition unit configured to acquire at least one two-dimensional image of the at least one livestock animal.

18. The device of claim 16, wherein said light-based marking device comprises a laser, a LED or a lamp.

19. The device of claim 16, wherein said light-based marking device further comprises a beam shaping device, a spatial light modulator, a deformable mirror, a galvanometric mirror, a spinning disk, a diffractive optical element, a phase mask, or a prism.

20. The device of claim 16, further comprising at least one pair of servo motors.

21. A touchless signaling and identification method for livestock, the method comprising:
providing a device including a computing system having one or more processing units and a light-based marking device comprising a coherent or not coherent light source, the device being operatively arranged in an unmanned aerial vehicle or being mounted on a fix or movable structure of a farm;
using the computing system to receive information related to at least one livestock animal;
using the computing system to obtain at least one feature of the livestock animal by:
implementing a characterization algorithm that uses received information related to the at least one livestock animal and an a priori model of the at least one livestock animal, the a priori model including indicators linking different parts, contours or shapes representative of the at least one livestock animal or indicators about psychological/health/behavior conditions of the at least one livestock animal, or
matching the received information related to the at least one livestock animal with information stored in a memory or database;
using the computing system to decide based on the type of livestock animal to be signaled, a part of the at least one livestock animal or an area nearby the at least one livestock animal where to project an identifier, the identifier being associated with the at least one feature obtained from the livestock animal; and
using the light-based marking device to mark the at least one livestock animal by projecting the identifier based on the deciding step, the marking being performed from a given distance from the livestock animal, the given distance being comprised within a given light range of the light-base marking device.

22. The method of claim 21, wherein the received information comprises:
a two-dimensional image, a three-dimensional point cloud image or a depth profile of the livestock animal; and
either a value of a distance between the livestock animal and an acquisition system used for acquiring the image, or a position or coordinates of the livestock animal.

23. The method of claim 21, wherein the identifier comprises a text message showing the at least one feature obtained from the livestock animal or a symbol including a color mark.

24. The method of claim 21, wherein the received information comprises at least one two-dimensional image comprising a plurality of livestock animals and a value of a distance between each one of the plurality of livestock animals and an acquisition system used for acquiring an image or a position or coordinates of each one of the livestock animals; the method further comprising using a processing unit of the computing system, the processing unit being configured to identify each one of the plurality of livestock animals included in the image by implementing a segmentation algorithm and deciding which ones of the plurality of livestock animals have to be marked by implementing a decision algorithm.

25. The method of claim 21, wherein the light-based marking device includes a laser, an LED or a lamp.

26. The method of claim 21, further comprising shaping or spatially modulating the identifier using: a beam shaping device, a spatial light modulator, a deformable mirror, a galvanometric mirror, a diffractive optical element or a spinning disk, included in the light-based marking device.

27. The method of claim 21, wherein the at least one feature obtained from the livestock animal comprises:
a body parameter of the livestock animal comprising a weight, a temperature, a body size and/or an age; and/or
a condition of the livestock animal including whether the livestock animal is sick, unhealthy, if it needs to be moved to another pen of a farm or if the livestock animal is identified as being aggressive.

28. The method of claim 21, wherein the livestock animal includes a pig, a bull, a cow, a sheep, a broiler, a duck, or a chicken.
